(19) United States
(12) Patent Application Publication
(10) Pub. No.: US 2011/0276887 A1
(43) Pub. Date: Nov. 10, 2011

(54) ORGANIZING, DISPLAYING, AND/OR MANIPULATING NETWORK TRAFFIC DATA

(76) Inventors: Alain J. Cohen, McLean, VA (US); David Manowitz, Washington, DC (US); Yevgeny Gurevich, Washington, DC (US); Edward A. Sykes, Cary, NC (US); Shobana Narayanaswamy, Kensington, MD (US)

(21) Appl. No.: 13/186,776

(22) Filed: Jul. 20, 2011

Related U.S. Application Data
(63) Continuation of application No. 11/829,923, filed on Jul. 29, 2007.
(60) Provisional application No. 60/821,020, filed on Aug. 1, 2006.

(51) Int. Cl. G06F 3/01; G06F 15/16

(52) U.S. Cl. 715/736

(57) ABSTRACT

A system and method for analyzing network traffic activity by displaying a collection of flow objects and receiving a user's selection of a traffic operation that is to be applied to a set of selected flow objects. Thereafter, the results of applying the traffic operation to the selected flow objects are displayed. The traffic operation may include a merge operation that provides statistics related to an aggregation of the flow objects. The traffic operation may also include a modification operation that modifies the selected flow objects, including, for example, a modification based on predicted traffic flow. Other traffic operations may also be provided, including providing access to plug-in traffic operation applications.

This application is a continuation of U.S. patent application Ser. No. 11/829,923, filed 29 Jul. 2009, which claims the benefit of U.S. Provisional Patent Application No. 60/821,020, filed Aug. 1, 2006.

### BACKGROUND AND SUMMARY OF THE INVENTION

The present system relates to the field of network activity visualization and particularly relates to a visualization tool that enables selection and/or manipulation of static and/or dynamically depicted network objects in a simplified manner.

A network is composed of a set of network objects, each with some associated behavior and properties. Activity on a network may be viewed based on static or dynamic network object data. In a static visualization, network activity is monitored and data related to that activity may be stored in a file. The data may relate to high level characteristics of the network activity, such as load and overall capacity and/or may relate to lower level characteristics such as node capacity, packet size, data type, etc. In a dynamic visualization, similar data may be provided as in the static visualization but the data is taken as live snapshots of current network activity are updated in a periodic manner (e.g., multiple times a second, minute, etc.). Further, a single snapshot of data from a dynamic visualization may be saved in a file for later analysis.

The data from the static and/or dynamic visualization may be utilized to determine desired network manipulations, such as redirection of traffic to alleviate traffic bottlenecks, etc. However, oftentimes, the tools utilized for visualizing network activity are different than the tools utilized for network manipulations. Accordingly, the user must visualize and analyze network activity in one tool/environment and then manipulate network characteristics in another tool/environment. After network manipulation, the user must then analyze network data captured (statically) or pertaining to (dynamic) a time after the manipulation to verify whether the network manipulation had a desired effect.

Further, there is limited support for visualizing aggregate information about the activity data in a useful manner. For example, in prior network modeling/visualization systems, there may be hundreds, thousands or more application demands and traffic flows within a network. For the user that wishes to analyze only a small subset of the activity/traffic, it can be very difficult to select and visualize the desired subset. Tabular reports and charts are available, but the ability to generate them for selected subsets of data without performing database-query-like operations is limited or nonexistent. Furthermore, if the user wants to make adjustments to a subset of that traffic, each object within the subset must be individually selected and modified.

It is an object of the present system to overcome disadvantages and/or make improvements in the prior art.

The present system includes a system, method and device for analyzing network activity by displaying in a first portion of a display, network objects according to an activity characteristic, receiving a selection of one or more of the network objects, and displaying in a second portion of the display, a further activity characteristic of the selected network objects according to a first criteria. The display of the network objects may be altered according to second criteria, which may include filtering criteria that removes network objects displayed in the first portion. Further details of the selected network objects may be displayed in a third portion of the display.

An activity characteristic may be changed according to second criteria. The activity characteristic may be changed by selecting one of the displayed network objects, such as by right-clicking, and selecting the second criteria from a resulting pop-up menu. The selected network objects may be displayed according to the changed activity characteristic. Receiving the selection of one or more of the network objects may include receiving a selection of a plurality of network objects. A graphical user interface (GUI) may be provided, wherein the acts of displaying and receiving are performed within the GUI. The network objects may be represented as folders provided as dynamic objects. The folders may be presented in a hierarchy, wherein the hierarchy represents a hierarchy of the activity characteristics of the network. The network objects may represent end-points of the activity characteristic.

The plurality of network objects may be displayed in buckets of network objects, for example as groupings of activity characteristics. The first criteria may be merged activity criteria based on common activity characteristics. Network activity that is not mapped to one of the plurality of network objects may be displayed for enabling mapping of the network activity to one of the network objects. The further activity characteristic may be selected to correspond to a given period of time. The further activity characteristic may be a historical activity characteristic. A future activity characteristic may be forecasted based on the historical activity characteristic. Forecasting the future activity characteristic may include selecting a method of the forecast calculation. Forecasting the future activity characteristic may include selecting a time period of the forecast.

The activity characteristic may be based on whether the network object supports a network service. The activity characteristic may be based on whether the network object meets a service level criterion. The further activity characteristic may be a simulated activity characteristic. The selected network objects may be grouped based on the selected network object's tolerance to a network activity problem, as well as sources, destinations, ports, communication protocols, bits per second, and packets per second of the selected network objects.

### BRIEF DESCRIPTION OF THE DRAWINGS

The invention is explained in further detail, and by way of example, with reference to the accompanying drawings wherein:

FIG. 1 shows an embodiment of the present system, wherein a GUI is provided having a navigation pane and one or more visualization panes;

FIG. 2 illustrates a navigation pane including a pop-up edit menu as may be provided by a selection within the navigation pane in accordance with an embodiment of the present system;

FIG. 3 shows a GUI of a visualization pane wherein a “Show Unmapped Traffic” check-box is checked in accordance with an embodiment of the present system;

FIG. 4 shows a GUI including illustrative visualization panes in accordance with an embodiment of the present system;

FIG. 5 shows a GUI for an exemplary manipulation menu item that may be integrated, for example, into a right-click menu item to enable users to predict what future activity volumes may exist based on existing activity provided in the network data in accordance with an embodiment of the present system;

FIG. 6 shows a process flow diagram in accordance with an embodiment of the present system; and

FIG. 7 shows a device in accordance with an embodiment of the present system.

### DETAILED DESCRIPTION

The following are descriptions of illustrative embodiments that when taken in conjunction with the following drawings will demonstrate the above noted features and advantages, as well as further ones. In the following description, for purposes of explanation rather than limitation, illustrative details are set forth such as architecture, interfaces, techniques, network elements, etc. However, it will be apparent to those of ordinary skill in the art that other embodiments that depart from these details would still be understood to be within the scope of the appended claims. Moreover, for the purpose of clarity, detailed descriptions of well known devices, circuits, modeling tools, analysis techniques and methods are omitted so as not to obscure the description of the present system.

It should be expressly understood that the drawings are included for illustrative purposes and do not represent the scope of the present system. In the accompanying drawings, like reference numbers in different drawings may designate similar elements. In addition, a first portion of a reference number may designate a figure wherein the reference number is provided.

The system and method described herein address problems in prior art systems. In accordance with the present system, modeling tools and information are provided within a visual environment including a user interface (UI), such as a graphical user interface (GUI). The GUI may be provided by an application running on a computer. The visual environment is displayed by the computer on a display device and a user is typically provided with an input device to influence events or images depicted on the display. GUI's present visual images which describe various visual metaphors of an operating system, an application, etc., that may be implemented on the computer.

The user typically moves a user-controlled object, such as a cursor or pointer, across a computer screen and onto other displayed objects or screen regions, and then inputs a command to execute a given selection or operation. Other applications or visual environments also may provide user-controlled objects such as a cursor for selection and manipulation of depicted objects in either of a two-dimensional or three-dimensional space.

The user interaction with and manipulation of the computer environment is achieved using any of a variety of types of human-computer interface devices that are connected to the computer controlling the displayed environment. A common interface device for GUI's is a mouse, trackball, keyboard, etc. For example, a mouse may be moved by a user in a planar workspace to move an object such as a cursor on a two-dimensional display screen in a direct mapping between the position of the user manipulation and the position of the cursor. This is typically known as position control, where the motion of the object directly correlates to motion of the user manipulation.

An example of such a GUI in accordance with an embodiment of the present system is a GUI for interaction within a network activity visualization to enable a user to navigate, view, analyze, create, and edit network activity, such as network traffic. Through use of the user interface in accordance with the present system, for example provided within the GUI, users are enabled to make use of network activity visualizations and to manipulate the activity, such as network traffic, in more flexible ways than previously possible.

The present system's user interface in one embodiment further provides a central window that enables the user to navigate, view, analyze, create, and edit network activity. In one embodiment, in enabling this functionality, the present system may provide one (1) or more, such as three (3) sets of interface portions, for example that may be implemented as plug-in program portions, referred to for simplicity as plug-ins, including arrangement/filtering, visualization, and manipulation. In one embodiment, each visualization may be implemented as separate programming portions. As may be readily appreciated, a plug-in may be a hardware and/or software module that adds a specific feature or service to a larger system, such as a network traffic collection system, network modeling system, etc. In accordance with an embodiment of the present system, one or more of the components of the present system may simply plug in to an existing system. One or more of the portions of the present system may enable developers to extend the behavior of the prior systems to accommodate new requirements.

In an alternate embodiment, one or more of the portions of the present system may operate as stand-alone elements (e.g., tool(s)) importing and/or exporting activity data from any source to enable operation in accordance with the present system.

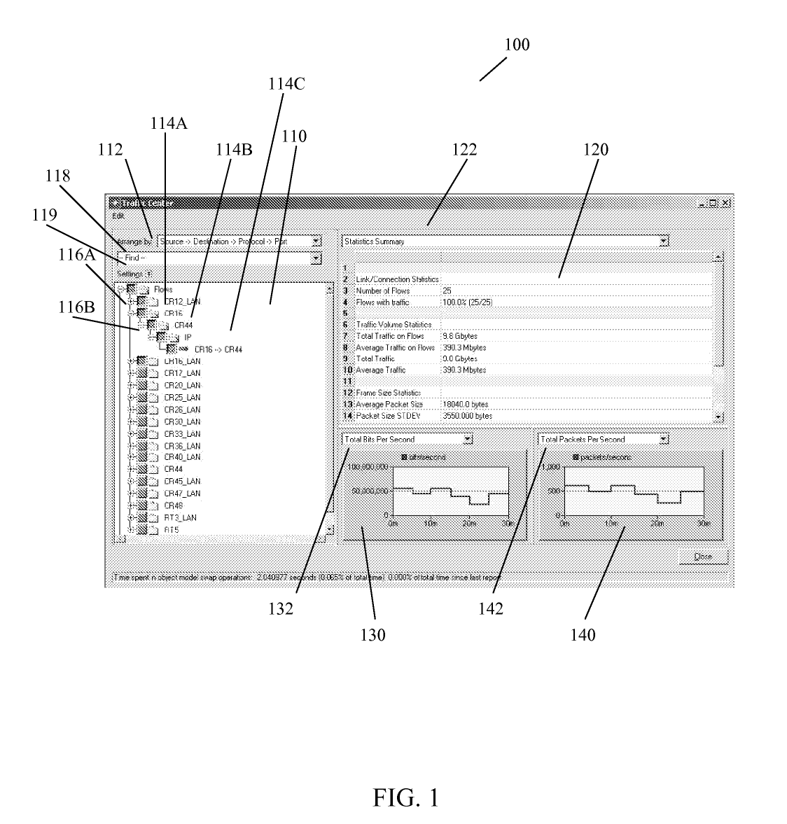

FIG. 1 shows one embodiment of the present system, wherein a GUI 100 is provided having a navigation pane 110 and one or more visualization panes 120, 130, 140. The GUI 100 may provide an environment for visualizing and/or manipulating network activity. To facilitate visualization and/or manipulation (e.g., changes to network activity constraints, etc.) of the network activity, the GUI may provide different panes that are directed to different portions of the visualization and/or manipulation process. For example, the GUI may present a typical UI including a windowing environment and as such, may include menu items, pull-down menu items, etc., such as menu items 112, 122, 132, 142, that are provided in a form that is typical of those provided in a windowing environment, such as may be represented within a Windows™ Operating System GUI as provided by Microsoft Corporation. The objects and panes of the GUI 100 may be navigated utilizing a user input device, such as a mouse, trackball and/or other suitable user input. Further, the user input may be utilized for making selections within the GUI 100 such as by selection of menu items, radio buttons and other common interaction paradigms as understood by a person of ordinary skill in the art.

To facilitate the following discussion, for purposes of simplifying a description, the term “activity” as utilized herein is intended to include any activity type related to a network object, including traffic, delays, collisions, housekeeping processes, communication protocol, bits per second, packets per second and any other operations and/or characterizations of a network object. For example, the term activity may include network object characteristics such as source of traffic, destination of traffic, nodes, ports, etc. The activity may be provided from either or both of static (e.g., historical) and dynamic (e.g., live) data collected regarding the network activity. In accordance with the present system, the navigation pane may be utilized to view, organize, select, and edit network objects and activity characteristics related thereto, such as objects 144A, 114B, 114C that have associated activity characteristics.

In one embodiment, network objects may be represented as folders and may be displayed hierarchically in a tree-view. As may be readily appreciated, other network topologies may be similarly represented in the navigation pane 110. In one embodiment, the network objects are arranged in the navigation pane 110 (e.g., hierarchically) according to characteristics of activity related to the objects. For example, the network objects may be traffic elements. In accordance with this embodiment, the traffic elements may be arranged in the navigation pane 110 according to characteristics of the traffic. An “Arrange by:” menu item 112 may be utilized to determine criteria for the view provided in the navigation pane 110. For example, selection of the menu item 112 as shown in FIG. 1, arranges the network objects according to:

Source->Destination->Protocol->Port.

The network objects depicted (e.g., such as by folders) within the GUI in accordance with the present system may be depicted dynamically based on the selection criteria. As such, in this embodiment, the depicted objects are not static objects in that a change in selection criteria and/or a change in the underlying characteristics associated with the object, such as may be provided by a change in live characteristic data, may result in a change in the depicted object and/or activity characteristic(s). For example, a change in a Source->Destination relationship for network objects, from either of a static source that is updated or from live data, may result in a change in the visualization provided in the visualization pane 110.

A settings dialogue box, accessible via button 119, may be utilized for setting the network topology depiction, such as a default depiction (e.g., hierarchical network depiction), as well as other settings of the visualization as may be readily appreciated. Objects in the tree-view may be expanded and/or collapsed to reveal more or less details related to the network objects. For example, a check-box 116A may be utilized to indicate that further details related to the object are available within an expanded view. Further, the checkbox 116A may be utilized to provide the expanded view by manipulation of a cursor over the checkbox and performance of a selection activity, such as a left mouse-click as may be readily appreciated. Selection of a minus-box 116B may be utilized to collapse the expanded view. In one embodiment, to select a given network activity, the user may select one or more network objects that are related to the activity of interest, such as end-points of the activity.

To select a network object, the user may first set an “Arrange by:” menu item 112 to determine criteria for the view (e.g., such as a hierarchical view) provided in the navigation pane 110. In this way, together with respective checkboxes and minus-boxes, the user may set the view so that a desired object is visible in the tree-view. A find selection menu 118 provided in the navigation pane 110 may expand the hierarchical view to a suitable level to reveal a network object that is added to the find selection menu 118. In one embodiment, a network object that is added to the find selection menu 118, may also be automatically selected. When a desired network object is revealed and selected (e.g., by a single left mouse-click and/or by use of the find selection menu 118), the activity related to that network object may also be selected and be provided within one or more visualization panes 120, 130, 140. For example, end-to-end traffic may be provided on flows and baseline loads may be provided on network links, connections, and paths.

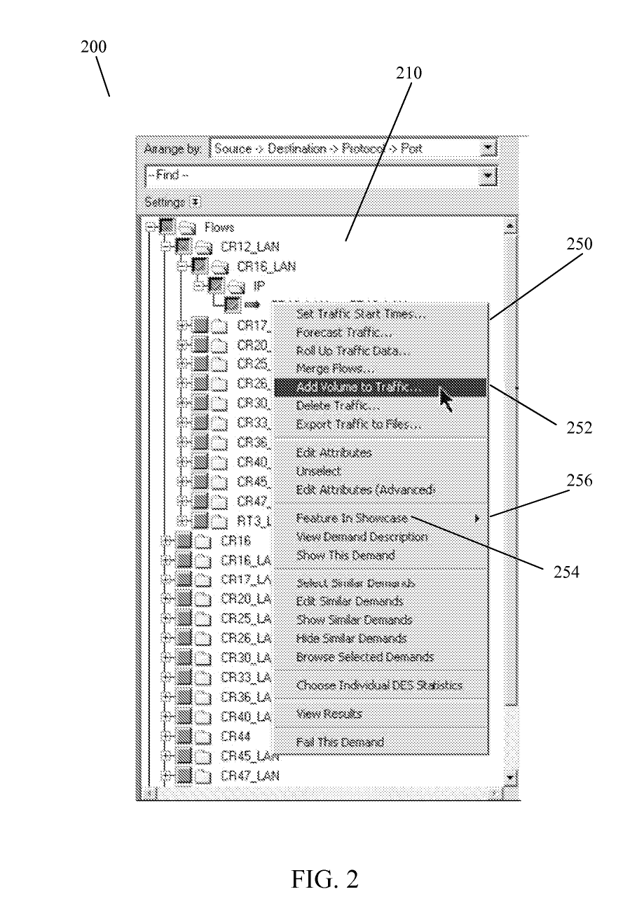

FIG. 2 illustrates a navigation pane 210 including a pop-up edit menu 250 as may be provided by a selection, such as a right-click, within the navigation pane 210. Through selection of one or more of provided menu items within the edit menu 250, such as may be provided by the right mouse-click within the navigation pane 210, the user may edit activity for one or more selected network objects. For example, by selection of a menu item 252, the user may add additional traffic volume to a selected network object. In a static visualization utilizing historical activity data, the user may edit parameters that affect activity for one or more network objects and thereafter, collect further activity data for analysis and/or further manipulations. In a dynamic visualization utilizing live (current) activity data, an effect of network manipulations may be viewed directly within one or more of the visualization panes 120, 130, 140.

In one embodiment, if a menu element, such as menu element 254 is provided with a right arrow 256, a further menu may be provided by selection of the menu element 254. In the illustrative embodiment shown in FIG. 2, the menu element 254 is a “Feature in Showcase” menu element that may provide further details of the selected network object in a separate visualization (e.g., a separate window). For example, selection of the “Feature in a Showcase” menu item may provide for further details related to the selected network object to be captured and/or visualized in the separate visualization.

To edit network object activity in the visualization pane 210, the user may select the one or more objects and then choose a desired operation from the edit menu 250. Illustrative edit menu 250 options may include a “Set Traffic Start Times” edit option to specify a calendar start time for activity (e.g., traffic) on selected objects; a “Forecast Traffic” edit option to discern future activity by forecasting trends in current network activity and to, for example, append new traffic to the current traffic or selected network objects, or to overwrite current traffic; a “Roll Up Traffic Data” edit option to roll data up into groups of data, such as data buckets (e.g., equal sized buckets, buckets based on ranges of a given network characteristic, etc.) based on activity profile attributes (e.g., range of collection times, range of packet activity levels, range of number of packet collisions, etc.) of selected objects to reduce system resources required to run simulation studies which may also reduce data granularity available for visualization; a “Merge Flows” edit option to combine selected traffic flows that have common characteristics for multiple flows between the same node/destination to reduce the number of flow objects provided in a visualization; an “Add Volume to Traffic” to increase traffic on selected network objects by scaling (e.g., percent of current traffic) or addition (e.g., new traffic in bits per second); a “Delete Traffic” edit option to delete traffic on selected network objects such that if a traffic flow is selected, this operation may delete the network object entirely and if a link, connection, or path is selected, this operation may clear the traffic data on that network object; and an “Export Traffic to Files” edit option may be utilized to export traffic on selected network objects to external traffic files, including traffic on flows and traffic links, connections, and paths, which may be edited (if desired) and may be imported into other scenarios and/or systems. Further generalized or traffic specific edit operations may be enabled through the current GUI including operations for editing traffic through a number of pull-down menu operations for editing an individual network object in a traditional manner.

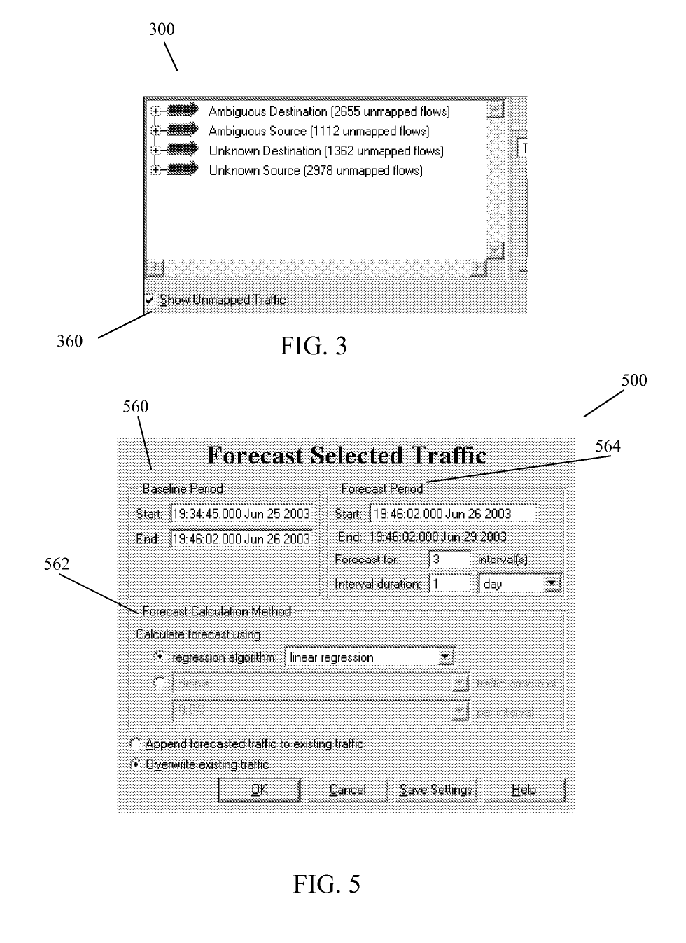

The navigation pane may also be utilized for visualization of other network activity, such as unmapped traffic. FIG. 3 shows a GUI 300 wherein a “Show Unmapped Traffic” check-box 360 is checked. The unmapped traffic GUI 300 enables users to see activity that was not mapped to network endpoints in the network activity data. In the GUI 300, the user may view flows individually or by endpoint address, and may manually assign one or both endpoints to network objects in the network activity data. In doing so, the user may effectively “bind” the element of traffic data (such as an end-to-end flow) to existing elements in the network topology provided in the navigation pane which may become the “source” and “destination” network elements associated with the traffic element.

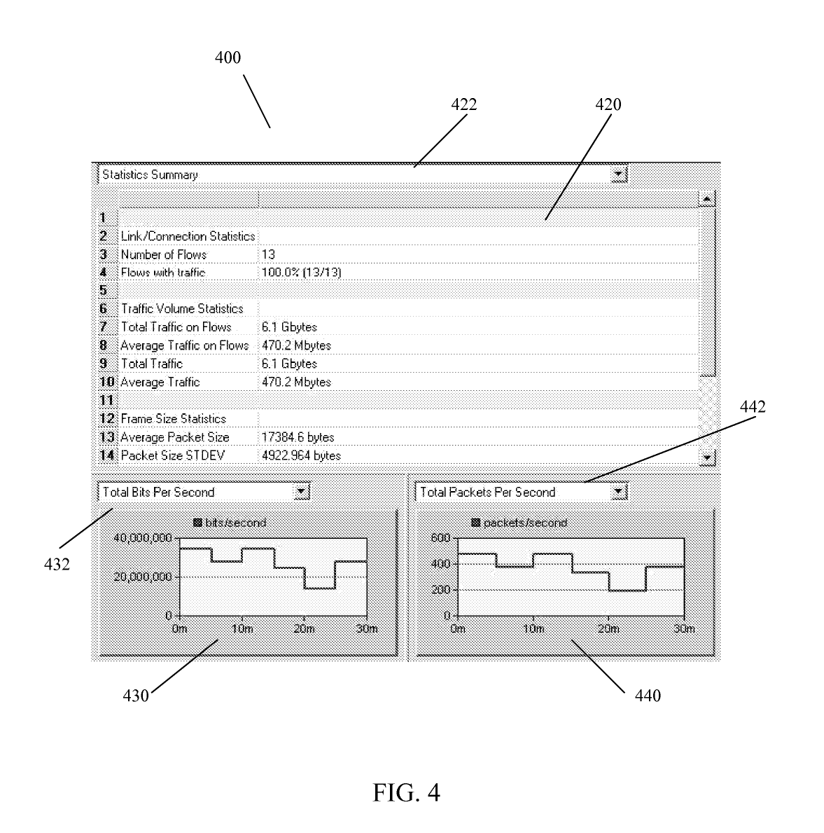

FIG. 4 shows a GUI 400 including illustrative visualization panes 420, 430, 440 in accordance with an embodiment of the present system. Through use of the one or more panes 420, 430, 440, the user may view relevant information about selected network object(s) (e.g., selected within the navigation pane 110 of FIG. 1) and activity. For example and in accordance with an embodiment of the present system, a selection within the navigation pane may be a selection of two or more network objects. In this embodiment, the activity characteristics depicted in one or more of the visualization panes 420, 430, 440 may represent a sum of the two or more network objects. For example, one of the visualization panes may represent a sum of activities for the selected network objects, such as a sum of network traffic, collisions, etc.

One or more of the visualization panes may be provided with a pull-down menu, such as pull-down menus 422, 432, 442, with options for viewing different types of information related to one or more selected network objects. Illustrative examples of options that may be provided within one or more of the visualizations panes 422, 432, 442 may include a “Network Domain” option to provide a network topology visualization within a respective visualization pane; a “Network Showcase” option to provide a visualization for emphasizing particular areas of interest; a “Statistics Summary” option to provide summary statistics about the activity on one or more selected network objects; a “Total Bits/Packets Per Second” option to provide traffic volume on one or more selected objects; a “Top N Talkers by Volume” option to visualize source/sink nodes that send or receive the most traffic; and a “ToS/Port Breakdown” option which may provide a pie chart showing a breakdown of traffic by Type of Service (ToS) or port number. In accordance with an embodiment, further parameters may be set related to one or more of the options provided within the visualization panes 420, 430, 440. For example, to specify a number (“N”) of ports within a visualization with the “Top N Talkers by Volume” option selected, the user may set a parameter to specify the number “N”.

In one embodiment of the present system, by implementation of the navigation and visualization panes as separate programming portions (e.g., plug-ins), other suitable extensions and customizations may be provided including and beyond those shown by way of example herein. In one embodiment, an external file approach for related data may be provided to enable a user to customize the manipulation and/or visualization for a particular user, system, application, etc. For example, visualization and/or editing procedures may be registered by means of a file describing the title, function name and library of required and optional procedures. The required procedure(s) (e.g., an “arrange callback”) may be passed objects whose type is one of the types specified by an “object types” field. In this structured format, a location structure may be created which describes the location of the element in the hierarchy of the network elements provided in the navigation pane. Optional procedures may be utilized for initialization and/or destruction of any stateful data structures that assist the arrange callback in producing the visualization.

Visualization procedures may be described by a “visualize” element. Visualization procedures may be made available from the pull-down menus (e.g., pull-down menus 422, 432, 442) in the one or more visualization areas 420, 430, 440. A “title” attribute may specify text that appears in the pull-down menu item (e.g., “Statistics Summary”). A “library” attribute may specify a library where the procedures may be found. Visualization procedures may also have a “return” attribute to specify what type of data may be returned by the pull-down menu item. Illustrative possible return attributes may include “custom”, “graph”, and/or “table” attributes. A “custom” visualization attribute may also specify resources and/or controls to configure a corresponding visualization. Visualization procedures provided by the pull-down menu items may have an “update” function, which may also have an optional “type” attribute. In one embodiment, the type attribute may either be set to “manual” or “automatic”. For example, by default the update function may be set to “manual”. In a case wherein the update function is set to manual, then the visualization area for this function may be provided with an “Update” radio button that a user may press for the update function to be called, thereby updating the visualization provided in the visualization pane. However, in a case wherein the value of the type attribute is set to “automatic”, such as by user selection of an “automatic” option, then the update function may be called any time the selection set changes or may be called periodically.

In accordance with an embodiment, a manipulation and/or action procedure may be registered as a right-click menu item in the topology provided in the navigation pane. Right-click menu items may be specified by “action” elements. A “title” attribute may specify text that appears in the right-click menu. A “library” attribute may specify a library where procedures related to the menu item may be found. The function that is performed (e.g., called) when the menu item is selected may be given by a “select” element.

By enabling functionality as separate programming portions, the GUI provided in accordance with the present system may be customized, enhanced, etc., by a user to meet particular needs of the user. An implementation as plug-in programming portions enables the user to take an off-the-shelf implementation and customize the implementation as much or as little as desired. In addition, future needs may be readily met utilizing a prior implementation or separate program which is customized with additional features implemented as plug-ins to the prior implementation or separate program. Further, the present system may be distributed as having basic, intermediate and advanced feature sets at different price points wherein differences in the feature sets are implemented as plug-ins to a basic feature implementation.

A “Feature in Showcase” menu item may provide an interface and workflow for selecting a subset of network objects. This menu item/tool, may be provided to further aid the user in visualizing and manipulating activity of interest. In one embodiment, the menu item may be provided as a plug-in to enable a selection of individual network objects or groups of network objects provided in the visualization pane such that endpoints of the activity (e.g., source/destination network objects) may be featured in a special showcase window along with activity of the network objects. Copending U.S. patent application Ser. No. 11/503,555, entitled “VISUALIZING A COMPLEX NETWORK BASED ON A SET OF OBJECTS OF INTEREST”, incorporated herein by reference thereto as if set out in its entirety, describes an interface and workflow in accordance with this embodiment of the present system. In a further embodiment, simulation/analysis operations may be provided by the menu-item to compute end-to-end routes or paths of activity within the network and to show the activity endpoints alone or together with intermediate nodes along the activity path.

FIG. 5 shows a GUI 500 for an exemplary manipulation menu item that may be integrated, for example, into a right-click menu item to enable users to predict what future activity volumes may exist based on existing (e.g., statically or dynamically acquired) activity provided in the network data. The traffic selected in the GUI 500 may be analyzed during a baseline period 560. Thereafter, a forecasting method may be selected in a “Forecast Calculation Method” menu selection 562 (e.g., linear regression, percentage traffic growth, etc.) to enable a future traffic computation to span a time defined by a “Forecast Period” 564.

An arrange-by menu-item (e.g., see FIG. 1, menu 112), may be integrated into an application in accordance with the present system or may be provided as a plug-in to arrange network activity based on services and/or service groups that the services and/or service groups support. For example, the menu item may utilize a service model definition to determine which activity elements (e.g., traffic flows) support a service. Copending U.S. patent application Ser. No. 11/507,113 entitled “MANAGING SERVICE LEVELS ON A SHARED NETWORK”, incorporated herein by reference thereto as if set out in its entirety, describes using a service model definition to determine which network objects support a service in accordance with an embodiment of the present system. In this way, arrangements and/or network objects may be provided (e.g., visualized and or manipulated) rooted at services that are supported by the arrangement and/or network objects. For example, in a hierarchical topology provided in the visualization pane, child elements of the services may be visualized with the traffic flows that support the service. In an alternate selection, an arrangement of group flows may be based on a success or failure in meeting service level criteria (e.g., delay, hop count, jitter, etc.) such that those traffic flows which meet service criteria are placed in a group distinct from the traffic which fails its associated service level criteria.

In a further embodiment in accordance with the present system, a “time window” menu item may incorporate a graphical control element for the user to specify a starting and ending time range. By specifying the time window, the user may effectively perform a global filtering operation such that the set of activity available for visualization and/or manipulation provided in the navigation and/or visualization panes is filtered to only the activity occurring (e.g., having measured volume levels) within the specified time range. In this way, traffic for which no data is recorded for the user-specified time range may be filtered out so that it no longer appears in the visualization pane and therefore is not selectable for visualization and/or modification. Furthermore, visualizations that report on activity volumes/levels may be limited to operate on only the activity volumes recorded for the user-specified time period. For example, for a visualization showing aggregate bits per second over time for a selected set of activity, filtering based on a time interval may cause a visualization (e.g., a graph) to only display the activity of the selected network objects, services, etc., for the time range selected, thereby omitting any display of activity outside of the provided time window.

In an embodiment in accordance with the present system, network performance data, such as Quality of Service (QoS), etc., may be incorporated into a visualization to incorporate performance data that is relevant to activity demands in one or more of the provided visualizations. In one embodiment, the performance data may be collected directly from a network. For example, polling using Simple Interface Management Protocol (SNMP) may be utilized for router interface Management Interface Base (MIB) data (e.g., utilization, loss, errors, etc.) along a path the activity takes. Further, active performance measurement data may be associated with current traffic demands. For example, traffic visualized within a visualization pane may represent aggregate pair traffic, such as within a given city, network portion, etc., and a data insertion device, such as a Brix probe, may be used to send synthetic packets to measure delay, jitter, loss, Mean Opinion Score (MOS), etc., associated with the traffic. In an alternate embodiment, the data may be generated by modeling the network and simulating aspects of performance.

In either case, whether utilizing measured or simulated performance data, a visualization provided in an embodiment in accordance with the present system may associate individual network objects and characteristics, such as traffic objects (e.g., flows), with its relevant performance data. This visualization enables activities, such as network traffic, to be grouped by performance categories (e.g., group by traffic by differing ranges of performance, group all demands that experienced a performance problem on a particular network device or interface, etc.).

In accordance with a further embodiment, the present system may represent activity data that has been read or imported from one or more of static data sources and live data sources, such as a live data feed. In a further embodiment, the data source may update one or more portions of the data utilized for providing the present visualizations, periodically in any defined period (e.g., every 60 seconds, every 5 minutes, every 15 minutes, etc.). These updates may be provided as a portion of an activity of a system having other tasks, such as tasks not related to visualizations and/or manipulations in accordance with the present or may represent a task of a dedicated system. The updates may be requested by a portion of the present system, such as through a plug-in module, or may be forwarded as a result of a task relegated to a further system.

In accordance with the present system, upon receiving the updated set of activity information or some time thereafter, the present system may recompute statistics, arrange-by membership, and/or update visualizations or portions thereof. Accordingly, a dynamically updating interface may be provided, such as by a plug-in, as new activity data arrives. An aging mechanism may be employed to roll off or age out (e.g., expunge, decrease relevance, filter) older activity data. For example, activity data may be filtered to avoid having an effect on a presentation of data to maintain activity data memory usage at a substantially constant level. Other activity data may be expunged, filtered, etc., based on a user and/or system determinable event, such as based on a determination that the activity data represents an infrequent event and therefore may be of little interest for analysis. For example, activity data related to an infrequent application deployment may be of little interest when performing analysis and/or manipulations related to day-to-day network activities. In another embodiment, all activity data related to other than the user and/or system determinable event (e.g., the infrequent event) may be expunged because it is of little interest for analysis of network activity related to the infrequent event. For example, activity data related to the infrequent application deployment may be of interest when performing analysis and/or manipulations related to the infrequent application deployment.

In one embodiment, the present system may provide a capability to limit (e.g., filter) activity related to a given range of time (e.g., minutes, hours, etc.) during which the activity data should apply (e.g. only forecast based on business hour network activities). The present system may also incorporate and/or provide periodic (e.g. seasonal) analysis for focused visualizations including forecasts.

The present system may provide additional visualization and/or manipulation options, such as a smart aggregation by port, organize traffic by known ports, etc. A manipulation in accordance with the present system may enable reconciling loads and flow data through network routing manipulations. A de-duplicating of flow data (activity) may be provided based on routing knowledge. In accordance with an embodiment of the present system, network activity may be visualized and/or manipulated by dragging and dropping a set of elements from one folder to another. In accordance with a further embodiment, batch or macro operations for performing an action on each of the selected folders may be visualized and/or manipulated instead of an aggregate of all the folders provided in a visualization.

In one embodiment, the visualizations and/or manipulations provided in accordance with the present system may be available as part of a modeling environment that includes a routing engine. Accordingly, the present system may utilize network activity data related to a hop-by-hop route of each network object (e.g., such as traffic flow) or virtual network objects (e.g., connections) such as provided by Multi-protocol Label Switching (MPLS), Label Switched Paths (LSPs), Asynchronous Transfer Mode (ATM), Permanent Virtual Circuit (PVC), etc. Accordingly, it may be natural for users of the present system to address questions and/or provide manipulations regarding individual activities, such as traffic flows, that may embed routing computations. One workflow of this type that may be enabled by the present system is a reasoning provided from a known network issue to identify traffic demands that are affected by it. For example, the present system may provide a visualization of network problems of various types, such as over-utilized links, excessive loss on a link, etc.

The present system may group flows, activities, etc., affected by these problems, characterize the nature of those flows (e.g., which ones are sensitive to the problem and which ones may be more tolerant of the problem), and/or provide some indication of a magnitude of the problem. Conversely, flows, activities, etc., not affected by these problems may be visualized. For example, in a case wherein a traffic demand is known to have a performance problem, such as determined from performance measurements taken directly from a network, or as determined by a user of the network such as provided in a trouble report, the present system may be utilized to enable a visualized walk of the route of the traffic flow (computed by the routing model). For example, performance data already collected along that path may be examined (e.g., router interface MIB data) or selectively turned on in an attempt to diagnose where the activity (e.g., traffic flow) is experiencing a problem.

In accordance with an embodiment, additional network objects, traffic elements, activities, flows, etc., may be added to enable visualization and/or manipulation. For example, flows may be imported and/or merged with existing traffic elements visualized by the present system. These additional elements may be automatically or manually added to the organization of traffic in an arrange-by navigation pane. In this way, by selecting the additional traffic, the visualizations may update to take this new additional traffic into account for displaying statistics, graphs, and other such visualizations.

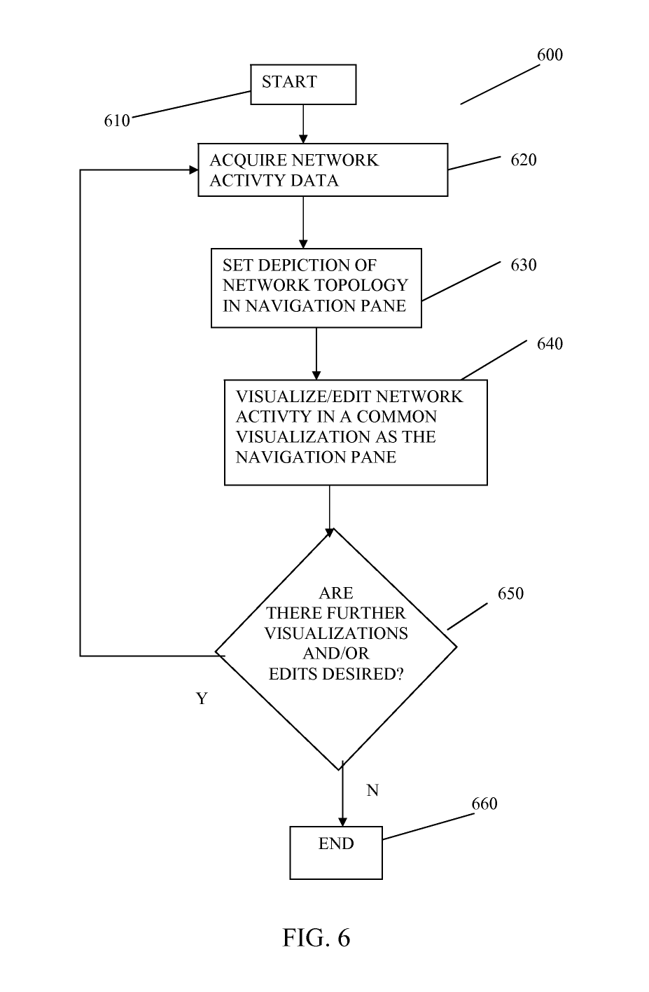

FIG. 6 shows a process flow diagram 600 in accordance with an embodiment of the present system. The process in accordance with the present system starts during act 610. Data related to network activity is acquired during act 620. The depiction of the network topology within a navigation pane is set during act 630. The depiction of the network topology (e.g., network objects) may be provided in any suitable visualization including a hierarchical visualization, a cloud visualization, etc. In one embodiment, a hierarchical visualization may be provided as a default network visualization upon startup, however, the default startup visualization may be user configurable through setting of a corresponding attribute. The network objects may be depicted (e.g., arranged) in the topology according to activity characteristics associated with the network objects. In another embodiment, the system may prompt the user for a desired startup visualization including a hierarchy of activity characteristics for visualizing the network objects. During act 640, the user may alter the depiction of the network objects including searching for desired network objects, deleting unwanted network objects, editing network object operating characteristics, etc. During act 650, it is determined whether the user desires further modifications to the network visualization or changes to network activity (e.g., operating) characteristics. In a case wherein further modifications are desired, new network activity data may be optionally acquired during act 620 and acts 630, 640, 650 may be repeated as desired. In a case wherein no further modifications are desired, the process ends during act 660.

Activity data visualized and/or manipulated in accordance with the present system may be exported from the present system to a separate system for further visualizations and/or manipulations. In this way, the present system may create a data file that is exported to the separate system for operations in accordance with the separate system, such as for analysis by the separate system. In another embodiment, manipulations to network objects and/or activity characteristics associated with the network objects may be exported to a system that controls management and/or manipulation of the network such that manipulations performed within the GUI of the present system, may be implemented. In this way, data, manipulations of data, etc., may be exported to or imported from the separate system.

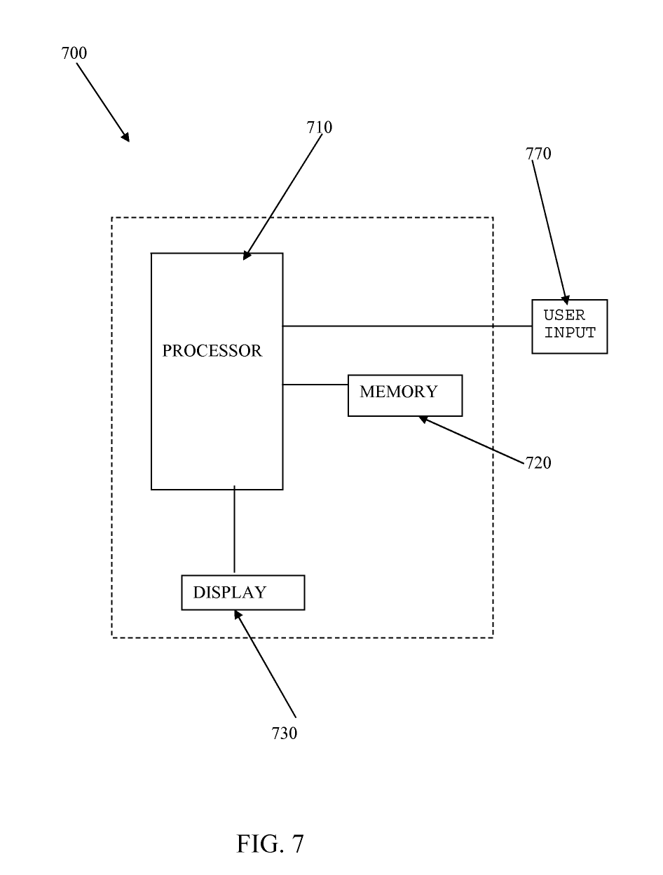

FIG. 7 shows a device 700 that may provide visualization and/or manipulations in accordance with an embodiment of the present system. The device has a processor 710 operationally coupled to a memory 720, a display 730 and a user input device 770. The memory 720 may be any type of device for storing programming application data, such as visualization and/or manipulation data as well as other data, such as performance data, etc. The programming application data and other data are received by the processor 710 for configuring the processor 710 to perform operation acts in accordance with the present system. The operation acts include controlling the display 730 to display content such as the GUIs 100, 200, 300, 400, 500. The user input 770 may include a keyboard, mouse, trackball or other devices, including touch sensitive displays, which may be stand alone or be a part of a system, such as part of a personal computer, personal digital assistant, or other display device for communicating with the processor 710 via any type of link, such as a wired or wireless link. The user input device 770 is operable for interacting with the processor 710 including interaction within a paradigm of a GUI, visualization and/or manipulation of network topology, activities, parameters, application attributes and/or other elements of the present system. Clearly the processor 710, memory 720, display 730 and/or user input device 770 may all or partly be a portion of a computer system or other device.

The methods of the present system are particularly suited to be carried out by a computer software program, such program containing modules and/or plug-ins corresponding to one or more of the individual steps or acts described and/or envisioned by the present system. Such program and/or program portions may of course be embodied in a computer-readable medium, such as an integrated chip, a peripheral device or memory, such as the memory 720 and/or other memory coupled to the processor 710.

The computer-readable medium and/or memory 720 may be any recordable medium (e.g., RAM, ROM, removable memory, CD-ROM, hard drives, DVD, floppy disks or memory cards) or may be a transmission medium (e.g., a network comprising fiber-optics, the world-wide web, cables, or a wireless channel using time-division multiple access, code-division multiple access, or other radio-frequency channel). Any medium known or developed that may store and/or transmit information suitable for use with a computer system may be used as the computer-readable medium and/or memory 720.

Additional memories may also be used. The computer-readable medium, the memory 720, and/or any other memories may be long-term, short-term, or a combination of long-term and short-term memories. These memories configure processor 710 to implement the GUIs, methods, operational acts, and functions disclosed herein. The memories may be distributed or local and the processor 710, where additional processors may be provided, may also be distributed or may be singular. The memories may be implemented as electrical, magnetic or optical memory, or any combination of these or other types of storage devices. Moreover, the term “memory” should be construed broadly enough to encompass any information able to be read from or written to an address in the addressable space accessible by a processor. With this definition, information available on a network is still within the memory 720, for instance, because the processor 710 may retrieve the information from the network for operation in accordance with the present system.

The processor 710 is capable of providing control signals and/or performing operations in response to input signals from the user input device 770 and executing instructions stored in the memory 720. The processor 710 may be an application-specific and/or general-use integrated circuit(s). Further, the processor 710 may be a dedicated processor for performing in accordance with the present system and/or may be a general-purpose processor wherein only one of many functions operates for performing in accordance with the present system. The processor 710 may operate utilizing a program portion, multiple program segments, plug-ins, etc. and/or may be a hardware device utilizing a dedicated or multi-purpose integrated circuit.

Of course, it is to be appreciated that any one of the above embodiments or processes may be combined with one or more other embodiments or processes or be separated in accordance with the present system. As should be clear, the present system enables a visualization and/or manipulation of network activity beyond that provided by prior systems.

Finally, the above-discussion is intended to be merely illustrative of the present system and should not be construed as limiting the appended claims to any particular embodiment or group of embodiments. Thus, while the present system has been described with reference to exemplary embodiments, it should also be appreciated that numerous modifications and alternative embodiments may be devised by those having ordinary skill in the art without departing from the broader and intended spirit and scope of the present system as set forth in the claims that follow. For example, while modifications to network operating characteristics are described in terms of actual implementations of the modifications on an operating network, these modifications may similarly be made within a simulation environment wherein the modifications are simulated and simulation data is acquired for accessing an affect of the modifications. Accordingly, these modifications and others are intended to be covered within the scope of the present system.

In addition, the section headings included herein are intended to facilitate a review but are not intended to limit the scope of the present system. Accordingly, the specification and drawings are to be regarded in an illustrative manner and are not intended to limit the scope of the appended claims.

In interpreting the appended claims, it should be understood that:

a) the word “comprising” does not exclude the presence of other elements or acts than those listed in a given claim;
b) the word “a” or “an” preceding an element does not exclude the presence of a plurality of such elements;
c) any reference signs in the claims do not limit their scope;
d) several “means” may be represented by the same item or hardware or software implemented structure or function;
e) any of the disclosed elements may be comprised of hardware portions (e.g., including discrete and integrated electronic circuitry), software portions (e.g., computer programming), and any feasible combination thereof;
f) hardware portions may be comprised of one or both of analog and digital portions;
g) any of the disclosed devices or portions thereof may be combined together or separated into further portions unless specifically stated otherwise;
h) no specific sequence of acts or steps is intended to be required unless specifically indicated; and
i) the term “plurality of” an element includes two or more of the claimed element, and does not imply any particular range of number of elements; that is, a plurality of elements may be as few as two elements, and may include an immeasurable number of elements.

What is claimed is:

1. A method of analyzing network traffic, comprising:
displaying, via a graphic user interface of a computer system, a collection of flow objects,
receiving, via the interface, a user's selection of a plurality of selected flow objects from the collection of flow objects, and a traffic operation,
applying, by the computer system, the traffic operation to the plurality of selected flow objects, and
displaying one or more results of applying the traffic operation to the plurality of selected flow objects.

2. The method of claim 1, wherein the collection of flow objects is displayed in a hierarchical form.

3. The method of claim 1, wherein each flow object includes a source and a destination of traffic flow associated with the flow object.

4. The method of claim 3, wherein each flow object includes a protocol associated with the traffic flow.

5. The method of claim 3, wherein each flow object includes a port associated with the traffic flow.

6. The method of claim 1, wherein receiving the user's selection includes receiving a set of characteristics, via the interface, and the method includes identifying the selected flow objects based on the set of characteristics.

7. The method of claim 1, wherein the traffic operation includes a merging of activity characteristics associated with the plurality of selected flow objects, and the results include one or more aggregate traffic statistics corresponding to the plurality of selected flow objects.

8. The method of claim 7, wherein the aggregate traffic statistics include a total amount of traffic associated with the selected flow objects.

9. The method of claim 7, wherein the aggregate traffic statistics include a number of collisions associated with the selected flow objects.

10. The method of claim 7, wherein the aggregate traffic statistics include a rate of traffic associated with the selected flow objects.

11. The method of claim 7, wherein the aggregate traffic statistics include a proportion of traffic associated with each of the selected flow objects.

12. The method of claim 1, including providing a system interface that enables a supplemental plug-in module to be coupled to the graphic user interface and the computer system, and wherein the applying of the traffic operation on the plurality of selected flow objects is performed by the supplemental plug-in module.

13. The method of claim 1, wherein the displaying of the collection of flow objects is automatically updated when one or more characteristics of one or more of the flow objects is changed.

14. The method of claim 1, wherein the traffic operation includes modifying the plurality of selected flow objects and the results include modified flow characteristics associated with the plurality of selected flow objects.

15. The method of claim 14, wherein the traffic operation includes setting one or more time limits on the plurality of selected flow objects.

16. The method of claim 14, wherein the traffic operation includes producing the modified flow characteristics based on a prediction of future traffic flow.

17. The method of claim 16, including providing the prediction of future traffic flow.

18. The method of claim 14, wherein the traffic operation includes merging characteristics of the selected flow objects.

19. The method of claim 14, wherein the displaying of the results is automatically updated when one or more characteristics of one or more of the selected flow objects is changed.

20. A non-transitory computer readable medium that includes a program that, when executed by a processor, causes the processor to:
display a collection of flow objects,
receive a user's selection of a plurality of selected flow objects from the collection of flow objects, and a traffic operation,
apply, by the computer system, the traffic operation to the plurality of selected flow objects, and
display one or more results of applying the traffic operation to the plurality of selected flow objects.

21. The medium of claim 20, wherein the collection of flow objects is displayed in a hierarchical form.

22. The medium of claim 20, wherein each flow object includes a source and a destination of traffic flow associated with the flow object.

23. The medium of claim 22, wherein each flow object includes a protocol associated with the traffic flow.

24. The medium of claim 22, wherein each flow object includes a port associated with the traffic flow.

25. The medium of claim 20, wherein receiving the user's selection includes receiving a set of characteristics from the user, and the program causes the processor to identify the selected flow objects based on the set of characteristics.

26. The medium of claim 20, wherein the traffic operation includes a merging of activity characteristics associated with the plurality of selected flow objects, and the results include one or more aggregate traffic statistics corresponding to the plurality of selected flow objects.

27. The medium of claim 26, wherein the aggregate traffic statistics include a total amount of traffic associated with the selected flow objects.

28. The medium of claim 26, wherein the aggregate traffic statistics include a number of collisions associated with the selected flow objects.

29. The medium of claim 26, wherein the aggregate traffic statistics include a rate of traffic associated with the selected flow objects.

30. The medium of claim 26, wherein the aggregate traffic statistics include a proportion of traffic associated with each of the selected flow objects.

31. The medium of claim 20, wherein the program causes the processor to access a supplemental plug-in module that enables the processor to apply the traffic operation to the plurality of selected flow objects.

32. The medium of claim 20, wherein the program causes the processor to automatically update the display of the collection of flow objects when one or more characteristics of one or more of the flow objects is changed.

33. The medium of claim 20, wherein the traffic operation includes modifying the plurality of selected flow objects and the results include modified flow characteristics associated with the plurality of selected flow objects.

34. The medium of claim 33, wherein the traffic operation includes setting one or more time limits on selected flow objects.

35. The medium of claim 33, wherein the traffic operation includes producing the modified flow characteristics based on a prediction of future traffic flow.

36. The medium of claim 35, wherein the program causes the processor to provide the prediction of future traffic flow.

37. The medium of claim 33, wherein the traffic operation includes merging characteristics of the selected flow objects.

38. The medium of claim 33, wherein the program causes the processor to access a supplemental plug-in module that enables the processor to apply the traffic operation to the plurality of selected flow objects.

39. The medium of claim 33, wherein the program causes the processor to automatically update the display of the modified flow characteristics when one or more characteristics of one or more of the selected flow objects changes.

40. A system comprising:
a display device,
a memory that includes a program, and
a processor that is configured to execute the program, causing the processor to:
display a collection of flow objects on the display device,
receive a user's selection of a plurality of selected flow objects from the collection of flow objects, and a traffic operation,
apply, by the computer system, the traffic operation to the plurality of selected flow objects, and
display one or more results of applying the traffic operation to the plurality of selected flow objects.

41. The system of claim 40, wherein the traffic operation includes a merging of activity characteristics associated with the plurality of selected flow objects, and the results include one or more aggregate traffic statistics corresponding to the plurality of selected flow objects.

42. The system of claim 40, wherein the traffic operation includes modifying the plurality of selected flow objects and the results include modified flow characteristics associated with the plurality of selected flow objects.
